(19) United States
(12) Patent Application Publication
(10) Pub. No.: US 2010/0071125 A1
(43) Pub. Date: Mar. 25, 2010

(54) Modular Shower Water-Proofing System and Method of Use

(76) Inventor: Gary Miller, San Diego, CA (US)

Correspondence Address: John Karl Buche;BUCHE & ASSOCIATES, P.C., 875 PROSPECT, SUITE 305, LA JOLLA, CA, 92037, US

(21) Appl. No.: 12/562,447

(22) Filed: Sep. 18, 2009

Related U.S. Application Data
(60) Provisional application No. 61/098,576, filed on Sep. 19, 2008.

(51) Int. Cl. A47K 3/28; B23P 17/00

(52) U.S. Cl. 4/613; 29/460; 29/527.4

(57) ABSTRACT

Disclosed is a washing-stall pan, related methods of use, and methods of fabrication.

### CROSS-REFERENCE TO RELATED APPLICATIONS

The present application claims the benefit of U.S. Provisional Patent Application Ser. No. 61/098,576 (filed on Sep. 19, 2008) entitled, “Modular Shower Water Proofing System and Method of Use.”

### STATEMENT REGARDING FEDERALLY SPONSORED RESEARCH OR DEVELOPMENT

N/A

### BACKGROUND OF THE INVENTION

1. Field of Invention

The present application is in the field of showers and baths (collectively, washing-stalls). Specifically, the present application is in the field of water-proofing shower floors. More specifically, the present application is in the field of modular apparatuses designed to water-proof shower or bath floors, which provide adhesive surfaces for tiles or other materials and methods of installation.

2. Background of the Invention

Typically, when a person desires to install a shower, there are a limited number of options available which provide water-proofed bathing areas. First, and one of the most common options, is the installation of a bathtub with a showerhead installed above the tub. These tubs are often constructed of materials such as plastic, ceramics or metal and have high sides which allow for the collection of water therein, and a drain for draining the water when the user is finished bathing. This option allows a person to take showers as well as baths. Although very common in homes today, this option suffers several limitations. For instance, homeowners often desire separate shower and bathtub configurations, as is the case when a Jacuzzi-style tub is installed. Typically, Jacuzzi-type tubs are not designed with shower heads installed above them. Thus, when a person installs a Jacuzzi tub, a separate stand-alone shower area is usually needed as well.

A person building a stand-alone shower typically must choose from one of three options. However, these options suffer severe limitations regarding the complexity of installation, time requirements, costs and problems with water-proofing. The first option requires the installation of a shower pan. Shower pans are common in the shower industry and are typically comprised of plastic. Similar to a small, shallow, square bathtub, these shower pans are graded from a higher edge to a low point near a center drain. However, unlike a tub, the edges of typical shower pans only have a shallow ridge which is designed to prevent the seepage of water from around the edges. Underneath, these shower pans have supports designed to allow the graded bottom of the shower pan to lie flush on a flat floor.

To install such a shower pan, the installer must insert the pan where the shower is desired. The installer then must install wallboard, such as Sheet Rock®, such that it lies flush with the top of the shower pan. Once done, a sealant is used to prevent seepage of water beyond the seam of the interface of the drywall and shower pan. Such water seepage is undesirable because once the interior of the walls becomes damp, mold and mildew can begin to grow. After creating a water-tight seal around the seam of the interface of the shower pan and drywall, the installer can then install tiles, stone or other materials on the drywall using any standard adhesive. Typically, those skilled in the art of installing tiles use an adhesive, generally comprising thinset mortar (“thinset”). The tile can be installed from the ceiling down to the interface where the drywall and shower pan meet. However, typical plastic shower pans are limited in that they are not designed to have tiles adhered to them. This is because the contours of such plastic floors were not designed with tiling in mind, nor is it clear that the plastic would provide suitably firm support for tile. Therefore, if the homeowner desires to have a tile-floored (or other material, such as stone) shower, this option is not available.

One alternative to using a plastic shower pan, that is suitable for those homeowners who wish to have a tile-floored shower, requires numerous complex steps. First, one must frame the desired shower area with wooden 2×4 boards. Also, an adequate “curb” must be framed to allow for several inches of water to collect in the shower, in the event the drain becomes clogged. The “curb” is typically one or more inches tall (but may otherwise vary) and framed on the threshold edge of the shower floor which is not adjacent to a wall, since showers such as this are typically designed with three walled surfaces and an opening for a door or curtain. Next, the floor, including curb, must be covered by a suitable material, typically tar paper. On top of the tar paper, the user must then install a waterproof lining and ensure that a water tight seal is created. Once the waterproofing is complete, the user may install dry wall and subsequently proceed with “mudding” the shower area, a process of applying a layer of mortar. After the initial mudding, the installer must allow the mudded area to cure and dry. Once dry, the installer must test the waterproof seal of the mudded area. Typically, this process requires hiring one or more professional tradesman. This mudded floor must also be graded, like the shower pan, such that the water drains from around the edges to a suitably positioned drain, which prevents the pooling of water.

To ensure that the seams of the interface of the concrete and wallboard are actually water-proof, sufficient time must be allowed for all mudding, adhesives and sealants to cure and dry before being tested. This typically requires an additional day or two of time to allow proper curing and drying. Once dry, the installer must run water around the area to test for leaks. If a leak is found, the seam must be resealed and allowed to dry again, thus requiring further delays. Once the entire shower area is determined to be water-proof, then tile, stone or other material suitable for use in a shower may be installed using thinset on the wallboard. Likewise, the tile, stone or other material may be installed on the mudded floor surface, which has a suitably rough surface to permit the adherence of tiles, stone or other suitable materials using thinset. As can readily be seen, this option requires the expenditure of significant time and resources, and likely the expertise of more than one professionally trained individual.

One final alternative, which also allows for application of tiles on the floor, is the installation of a shower pan comprised of foam, rubber or other similar material. These shower pans are designed similarly to typical plastic shower pans, yet are comprised of high density foam or rubber and are coated with a material suitable for affixing tiles, stone or other similar materials. As with typical shower pans, these foam shower pans do not require the expertise of a professional to “mud,” cure, and water-proof a concrete shower floor. And, unlike typical plastic shower pans, these foam pans can be adorned with tiles. However, these types of shower pans suffer other serious limitations. First, the walls of these high density foam pans are typically comprised of ½″ foam. When a person installs this foam pan into a designated shower area in a new construction home, the ½″ measurement allows one to install ½″ wallboard so that the interface of the shower pan and wallboard is flush. This will require the installer to waterproof the seam between the shower pan and the wallboard before applying tiles. However, a problem arises when a person wishes to install this high-density foam shower pan in a preexisting shower area which already has wallboard extending to the floor. In such a case, the homeowner may simply choose to install the foam shower pan into the designated shower area without regard to creating a seamless interface with the wallboard. Because of the ½″ thickness of the walls of the foam shower pan, choosing this option results in a ½″ protrusion from the wallboard. This difference presents a problem when one attempts to tile the interface between the wallboard and foam shower pan, since most tiles are much larger than ½″ and sizing tiles or otherwise adorning such a small surface would be extremely difficult and time consuming. And, the result would not appear uniform and aesthetically pleasing as compared to flush tiled walls. The alternative is to cut into the wallboard which is already in place in order to make room for the foam shower pan to be installed. This option may permit the installer to create a seamless interface between the wall and shower pan, but will require additional time, tools, and expertise to make an even and appropriately measured cut. An uneven or improperly sized cut into the wallboard will present problems for creating a seamless, and more importantly, a waterproof interface between the wallboard and shower pan. In that case, additional cuts and or replacement of the wallboards may be required, leading to delays and increased work and costs.

High density foam shower pans suffer from further limitations as well. Such shower pans are only as strong as the foam or other material out of which they are created. This is one reason why the walls of such pans must be at least ½″ wide foam, to provide enough strength. However, as noted above, this width limitation leads to the above-described problems of interfacing with the wallboard. If the foam is thinner, it might be too weak and the weight of a person stepping into an installed foam shower pan could deform the foam and thereby crack the tiles. Additionally, the water tightness of the corners of these pans are dependent on seals created when the foam boards are cemented or affixed to one another to form the shape of the shower pan. Imperfections in any of the seals can lead to water seepage, which is extremely undesirable. Finally, the cost of creating such foam shower pans is quite high, as the materials themselves are expensive.

### SUMMARY OF THE INVENTION

Accordingly, it is an object of the present invention to provide an apparatus capable of providing a water-proof shower or bath floor which also allows the installer to affix tiles, stone or other material to the surface of the floor, yet which can be ready for use without extensive delays or costs or professional expertise.

It is another object of the present invention to provide a method for installation of a water-proof shower floor which allows the installer to affix tiles, stone or other material to the surface of the floor, but which does not necessarily require the expertise of a trained professional or the pouring of concrete.

Other objectives of the invention will become apparent to those skilled in the art once the invention has been shown and described.

### BRIEF DESCRIPTION OF THE FIGURES

The manner in which these objectives and other desirable characteristics can be obtained is explained in the following description and attached figures in which:

FIG. 1 depicts a typical prior art molded plastic shower pan from a top right side view.

FIG. 2 is an exploded view of the applicant's invention, viewed from the top right side.

FIG. 3 is an assembled view of the applicant's invention, viewed from the top right side.

FIG. 4 is an assembled view of the applicant's invention, viewed from the side.

FIG. 5 is a cross-sectional view of the applicant's invention, viewed from the side and bisected in half.

FIG. 6 is a front side view of the applicant's invention.

It is to be noted, however, that the appended figures illustrate only typical embodiments of this invention, and therefore, are not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

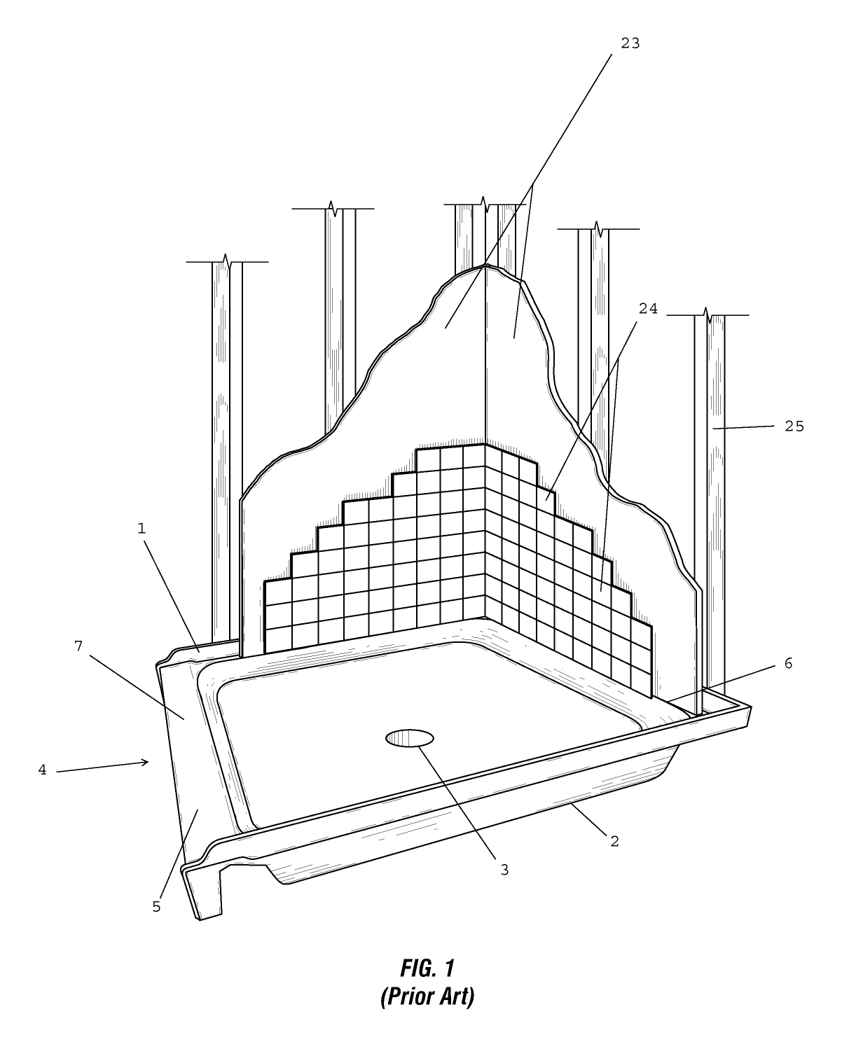

The present invention addresses the limitations set forth by the prior art and alternatives. FIG. 1 depicts a prior art standard molded plastic shower pan 4. Commonly used for years, this molded plastic shower pan 4 comprises a water seal lip 1 and a pitched floor 7 leading to a drain pipe connector 3. Typically, a molded plastic shower pan 4 is installed such that the underside support 2 fits flush against the bathroom subfloor. Standard wallboard, which is typically ½″ thick, is then installed such that the bottom edge of the board sits flush on top of the pan-wallboard interface surface 6. By installing the wallboard in such a manner the water seal lip 1 is positioned between the wallboard 23 and the wall framing studs 25. The installer then must seal the resulting seam located at the surface of the pan-wallboard interface 6 with a typical sealant, such as caulk. Doing so is intended to prevent water from seeping through the pan-board interface 6. Due to the absorptive properties of wallboard, when water seepage occurs it “wicks” up the wall, and thus, can lead to the undesired spread of mold and/or mildew. Important of note is that the typical water seal lip 1 of standard molded plastic shower pan 4 are not much more than approximately ½″ to 1″ in height and, in conjunction with any sealant applied, are the only protection provided by such pans against water seepage. The threshold curb 5 allows for entry and exit of the shower once the molded plastic shower pan 4 is installed and may accommodate the installation and use of a shower door or curtain (not pictured).

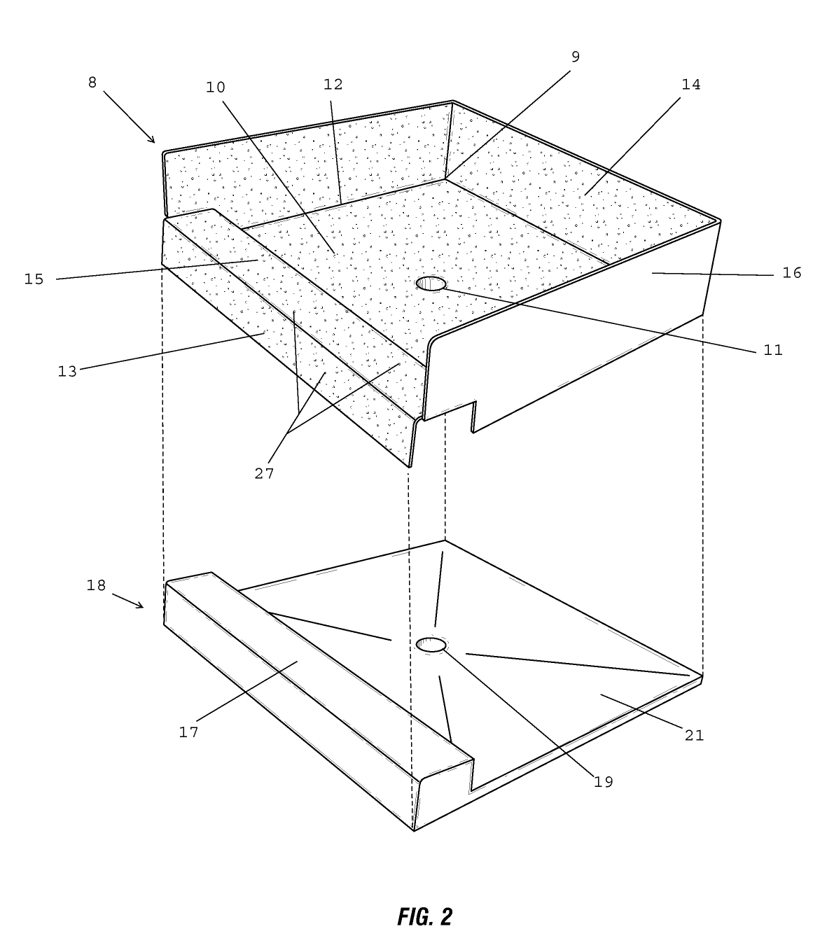

FIG. 2 depicts an embodiment of the invention of the present application in an exploded view from the front right perspective. A shower pan 8 is typically comprised of aluminum or other similar metal or suitable material, which is typically stamped into shape. This shower pan 8 is thus preferably water proof and/or water resistant. The shower pan 8 is typically formed by pressing said aluminum or other suitable material into the desired shape from a single piece of material. However, Applicant also contemplates a shower pan 8 which can be fabricated from several pieces of material with suitable characteristics, such as steel or aluminum, and/or welded such that the resulting pan displays the waterproof characteristics of a stamped pan. Such a pan may be formed or forged seamlessly via extruding, molding, or the like, or constructed with components that are fashioned together chemically, by welding, or other suitable means. Such a pan may be fashioned from a variety of materials, including but not limited to steel, aluminum, alloys, ceramics, plastics, high density polypropylene and polyethylenes, polyvinylchlorides and other materials that will be appreciated by those skilled in the art. These alternative methods of fabrication may be desirable for the construction of shower pans or baths in shapes which may not be achieved through the stamping process, or for shower pans which must be custom fit to the desired shower area. Although alternate materials are contemplated to be used for forming a single-piece, waterproof shower pan, such as the present invention, Applicant has found that one preferred embodiment is to use “0-1 tensile” strength or stronger aluminum. The Applicant has found material of this strength allows the shower pan 8 to be formed, yet still provides the desirable characteristics described herein. For instance, Applicant contemplates that the shower pan 8 could be designed from a high strength plastic, whether through a molding process or vacuum sealing process. Also, the shower pan 8 can be formed to fit various standard shower sizes, such as 37″×37″, 37″×48″, 33″×60″, 42″×48″, 48″×48″, 37″×60″, 37″×72″, 48″×37″, and even with shower designs featuring a 2 or 3-sided curb design. The shower pan 8 could also be designed such that the water shields 16 extend higher than those depicted in the present drawings, and could even extend to the ceiling, and thus, be installed without the need for wallboard. In one nonlimiting example, the shower pan 8 is formed from stamped aluminum ranging from 0.020″ to 0.060″ inches in width, with 0.050″ being still more preferable. Other variations in dimensions, size and shape are also contemplated, such as custom fitting, and will be readily apparent to those skilled in the art. Likewise, the drain pipe connector 11 can be positioned in a variety of places, such as centrally located, or to one side, depending on the size of the shower pan 8 being used, the structural limitations of the shower area, and desires of the installer.

The present shower pan 8 provides several advantages over the prior art. First, because the shower pan 8 is typically comprised of a single piece, it will be waterproof at the water tight corner bends 9 and water tight seam folds 12. There is no need to apply sealant or adhesive to ensure that the water tight corner bends 9 or water tight seam folds 12 are actually waterproof, since they are suitably comprised of a single piece of material, usually metal. This embodiment offers the further advantage over the prior art of eliminating the need for “mudding,” “hot-mopping,” and/or waterproof testing, which are associated with alternative methods, and can cause delays and result in increased costs.

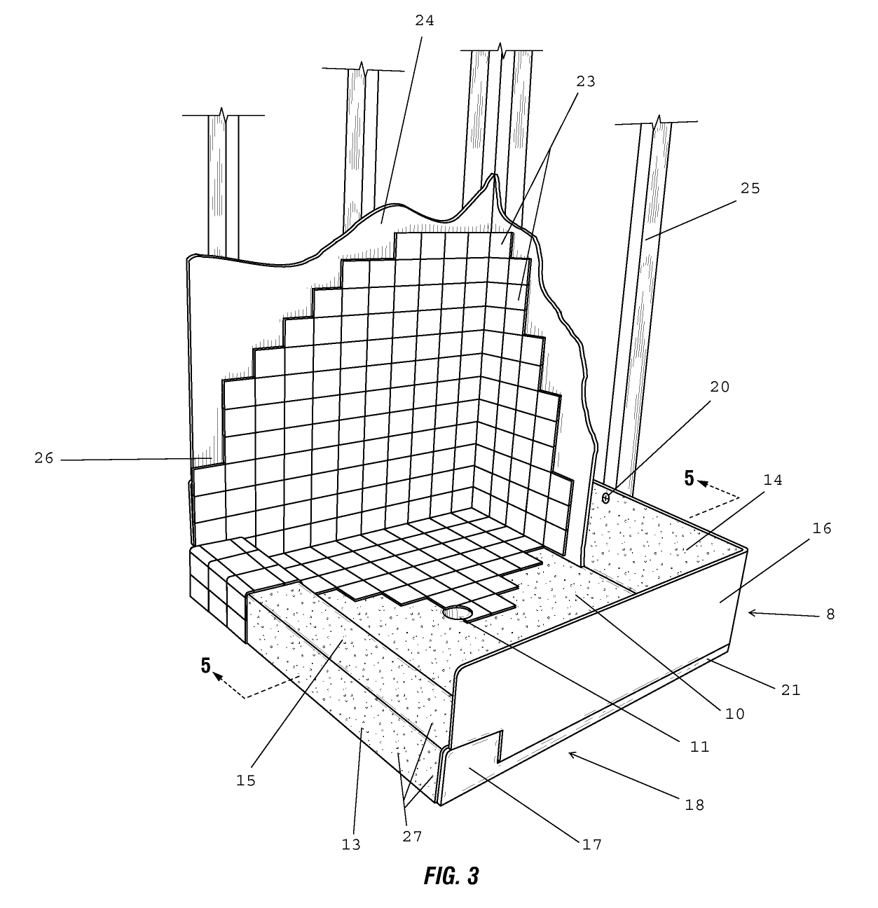

Still referring to FIG. 2, a further advantage of the embodiment of the present invention is found by reason of the water shields 16. The water shields 16 are designed to address the water seepage issues common with the typical plastic molded shower pan 4 of FIG. 1. Unlike the water seal lip 1 of the plastic molded shower pan 4 of FIG. 1, the water shields 16 of FIGS. 2-6 are designed to suitably accommodate the installation of wallboard 23 down to the floor of the shower pan 8. This preferable feature is best exhibited by FIG. 3. Because the water tight corner bends 9 and water tight seam folds 12 do not require any further sealant to ensure a watertight fit, there is no further need to cut or otherwise adjust the wallboard to accommodate the shower pan 8 into the designated shower area. In fact, the shower pan 8 is secured into place by fastening it directly to the wall framing studs 25 with the use of fastening means 20, e.g., screws, nails, bolts, etc., or other commonly used fastening means in the art. The wallboard 23 is then fastened directly to the wall framing studs 25 with the use of fastening means 20 at points above the shower pan 8. The wallboard extends into the shower pan 8, such that the water shields 16 abut the wall framing studs 25, and the wallboard 23 is installed over the interior surface 14 of the water shields 16. Alternatively, the wallboard can be installed first with the shower pan 8 water shields 16 fastened directly to the wallboard with the use of fastening means 20. This alternative method may be useful when installing a replacement shower pan in a bathroom which already has wallboard extending from the floor to the ceiling.

In one non-limiting example, the water shields 16 are of a height in the range of 2″ to 24″, with a 10″ being a further desirable size. However, Applicant also contemplates embodiments which exhibit water shields that extent from the subfloor to the ceiling, in which case the need for wallboard would be completely eliminated. In one embodiment of the invention of the present application, the wallboard 23 extends on the inside of the shower pan 8 until it reaches the pitched floor 10. Unlike the prior art molded plastic shower pan 4, of FIG. 1, or typical foam shower pans (not pictured), the wallboard 23 in the present invention can be installed flush with the pitched floor 10 of the shower pan 8, as shown best in FIG. 3. This allows tiles 24 to be installed on the wallboard 23 from any point above the shower pan 8, up to the ceiling, continuous to the pitched floor 10 of the shower pan 8. The present shower pan 8 embodiment also makes continuous tiling easier from the pitched floor 10 itself, up along the wall.

Another problem addressed by the present invention is that of providing a shower pan 8 with a suitable adhesive surface for tile, stone or other suitable materials. Typically, tile is applied to a surface using thinset. Thinset is applied to a wall or floor surface when wet and then the installer affixes tiles thereon. While wet, the installer can adjust the tiles in a desirable design. Once the thinset dries, the installer applies grout to fill in any spaces between the individual tiles. When the grout dries, a waterproof surface is created between each tile. As mentioned above, the standard molded plastic shower pan 4 of FIG. 1 does not provide an adequate surface to which one may affix tile. And, although the above-described foam shower pan is suitable for affixing tile, it is limited in its design as described above, since due to its thickness it cannot fit flushly behind or in front of the wallboard and still permit uniform tiling. The present invention addresses both of these issues since it exhibits minimal thickness, strength, and suitable surfaces for tiling. Again, the benefit of thin walls is that the wallboard 23 may be installed on the inside of the shower pan 8 and continued uninterrupted to the ceiling.

One limitation, however, of using aluminum and similar materials to form a shower pan, and which has frustrated the development of such inventions until now, is that these materials exhibit very low coefficients of friction on their surfaces. This lack of friction prevents adhering tile, stone or other similar materials directly to aluminum, or similarly low friction materials, using standard thinset or other known alternatives in the art. To address this problem, the interior surface of the shower pan 8 is coated with a strong adhesive, such as epoxy, which bonds to low friction surfaces. Then, silica sand or other similar abrasive material is applied to the wet epoxy. Once the strong adhesive dries, the sand is bonded to the aluminum surface creating a coarse friction coating 27. Although alternative bonding materials with similar attributes may be employed, the present embodiment uses “201 epoxy.” Likewise, although alternative materials with similar attributes may be used to create a friction coating 27, the present embodiment makes use of silica sand. Following the drying of the adhesive and bonding of the friction materials, the interior surface of the shower pan 8 is suitable for applying tile, stone or other similar material with the use of typical thinset 26. What is more, after such drying, because the thickness of the water shield 16 is very small, typical thinset 26 can be applied directly to the wallboard 23—water shield 16 interface and tiles 24 will still fit flush. Also, wallboard 23 can be adhered to the interior surface of the water shields 14 with the use of standard thinset. By applying tiles 24 in such a manner, and then later applying standard grout to the spaces between tiles, a waterproof surface is created without the need for any further sealants or testing.

Another component of the embodiment of the present application is the fitted foam support 18. As shown apart in FIG. 2, and in conjunction with the shower pan 8 in FIGS. 3-6, the fitted foam support 18 provides support to the shower pan 8. What is more, the shower pan 8 suitably exhibits a pitched floor 10, which facilitates the water draining from the edges of the shower pan 8 down to the drain pipe connector 11 and eventually to the home's plumbing system. A typical shower pan floor is pitched at a ¼″ per foot slope, although Applicant contemplates other slopes which would adequately drain water from the edges of the pan to the drain, wherever it is located. However, a consequence of this pitched floor 10, is that the bottom surface of the shower pan 8 is not level and would not fit square with a level subfloor on its own. The fitted foam support 18 solves this problem by providing a pitched floor support surface 21, which is designed to interlock according to the slope of the pitched floor 10 of the shower pan 8. FIG. 2 also displays the drain pipe connector aperture 19 of the fitted foam support, which permits the drain pipe connector 11 of the shower pan 8 to connect to the sewage system of the home (not pictured). Typically, this connection is achieved through the use of a cylindrical drain pipe gasket (not pictured) which is sized to fit inside the drain pipe connector 11 and around the pipe leading to the sewage system (not pictured) and which suitably creates a watertight seal. However, Applicant contemplates alternative methods of drainage, which are also apparent to those skilled in the art.

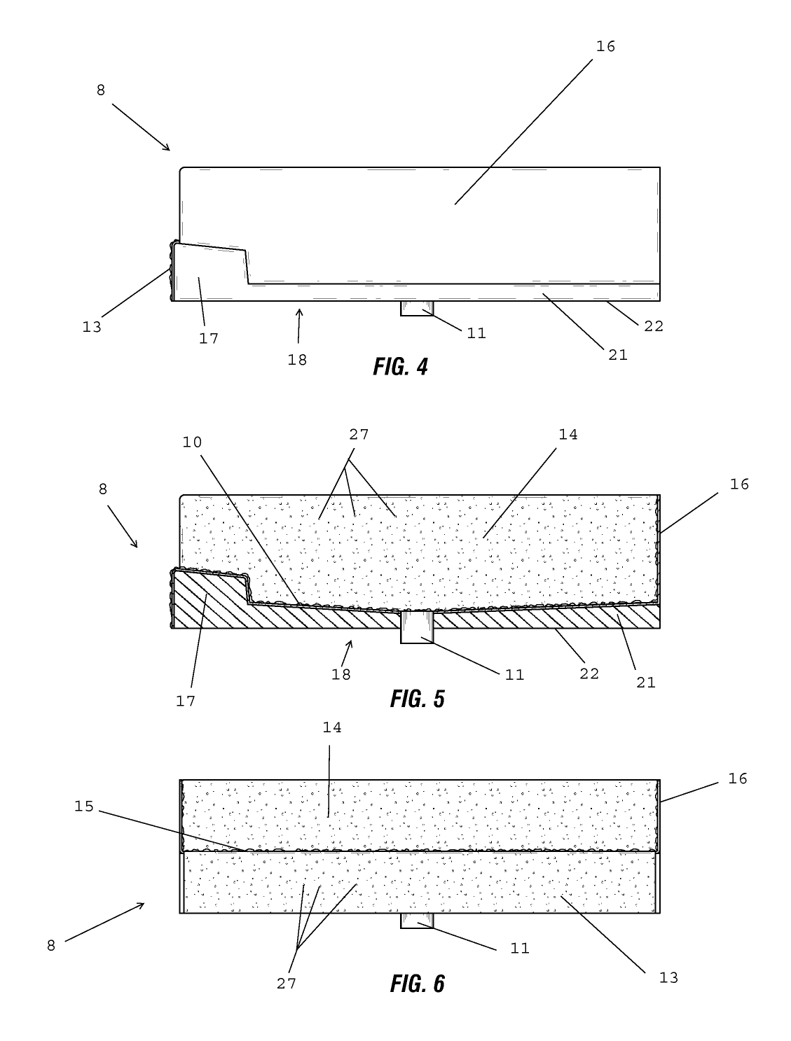

FIGS. 3-6 show the shower pan 8 and the fitted foam support 18 fitting together flush. The fitted foam support 18 also provides a level foam subfloor surface 22 which is designed to fit squarely flush on a level subfloor. FIG. 4 shows the fitted foam support 18 and shower pan 8 fit together and the levelness of the foam subfloor surface 22. FIG. 5 shows a cross-sectional view, in which the pitched floor support surface 21 of the fitted foam support 18 fits flush with the lower surface of the pitched floor 10 of the shower pan 8.

FIGS. 2-3 also depict the integrated threshold curb 15, which is likewise coated with a friction coating 27 and designed to accept tiles 24, stone or other similar materials. The width of the integrated threshold curb 15 is sized to accept tile 24 of standard sizes, allowing for proper edging, but may be adjusted to other desirable widths and dimensions. Likewise, the threshold support 17 of the fitted foam support 18 is designed to fit snugly underneath and support the integrated threshold curb 15, and thus, will likewise vary depending on the dimensions of the integrated threshold curb 15. Also, the threshold curb front 13 is likewise designed with the friction coating 27, such that tile 24 or stone or other similar material may be affixed thereto, and size may vary depending on the characteristics of the materials to be applied or as otherwise desired and will be readily apparent to those skilled in the art. FIG. 6 is a front view of the shower pan 8 which provides a clear view of the threshold curb front 13, the interior surface of the water shield 14, and the drain pipe connector 11. It is also noted that FIGS. 2, 3, 5, 6 all display the shower pan 8 with the friction coating 27 applied, making the metallic surface suitable for applying standard thinset 26 and tiles 24.

FIG. 5 also depicts the drain pipe connector 11. Like with the standard molded plastic shower pans 4 of FIG. 1, a waterproof seal is created by installing a simple drain pipe gasket (not pictured) inside the drain pipe connector 11 that fits snug around the pipe that leads to the home's plumbing (not pictured).

Comparing the tiling associated with the standard molded plastic shower pans 4 in FIG. 1, which terminates at the pan-wallboard interface surface 6, with the shower pan 8 in FIG. 3, one can see the finished product of the present invention is drastically different. Although a shower pan 8 is used in the present system and method, the resulting finished product leaves no indication that a shower pan 8 was ever used, and the resulting finished product of the present invention resembles a tile-floored shower, similar to those constructed using the “mudding” method. However, the embodiments disclosed herein suitably provide the added benefits of reduced needs for time, cost and effort of mudding, hot-mopping and/or waterproof testing.

Disclosed is a shower pan, and method of its manufacture, which is typically formed by stamping sheets of metal, typically aluminum, into a desirable shower pan or bath pan shape, with a drain pipe connector provided, a threshold curb, and walls. Because the disclosed shower pan is usually stamped of a single piece of metal, the folds and corners do not suffer the limitations of gaps or cracks, as is the case with pans comprised of several individual pieces which are welded or otherwise assembled together. Although applicant contemplates making the instant shower pan 8 using other materials and methods, including but not limited to welding, plastic molding, forging and vacuum sealing. The presently disclosed shower pan also may feature a fitted support pad, typically comprised of high density foam, which may be formed to closely interlock with the pitch of the shower pan floor and provide a level surface for installation on the subfloor of the shower area or otherwise adapted to fit the desired floor surface. The presently disclosed shower pan embodiments may further comprise an aluminum surface coated with a strong adhesive, typically epoxy, which suitably bonds a material with desirable friction properties, such as sand or silica sand, after which allowed to dry, provides a suitable surface for adhering thinset and installing tile thereon. The shower pan is also connected to a suitable drain pipe for sewage.

Also disclosed is a method for waterproofing a shower area, which comprises the steps of placing a shower pan in a desired shower area and using a fastening means to secure said shower pan to the wall framing studs. Next, one installs wallboard using a fastening means directly to the wall framing studs, with the wallboard extending to the floor of the shower pan on the inside of the shower pan. The walls of the shower pan are suitably sized such that they fit between the wallboard and the wall framing studs to which they are fastened, yet still provide a uniformly flat wallboard surface suitable for tiling. Thereafter, thinset is applied to the exposed areas of the shower pan, including the curb, the floor, and the wallboard in a desired design and to a desired height. Once the thinset dries, a typical grout is used to create waterproof interfaces between tiles. The shower pan is thereafter completely covered by tile and/or wallboard, and does not appear visible or exposed. The shower pan is also connected to a suitable drain pipe for water drainage.

Other assembly methods may be practiced depending on the use of alternative embodiments described herein, and will be readily apparent to those skilled in the art.

I claim:

1. A washing-stall comprising a floor, drain pipe connector, and at least one water shield.

2. The washing-stall of claim 1 further comprising a friction coating.

3. The washing-stall of claim 2 wherein said friction coating is on at least one surface of the water shield(s) and on said floor.

4. The washing-stall of claim 2 further comprising a friction coating.

5. The washing-stall of claim 1 fashioned from at least 0-1 tensile strength aluminum.

6. The washing-stall of claim 1 fashioned from stamped aluminum ranging from 0.020 to 0.060 inches in width.

7. The washing-stall of claim 1 being fashioned of one piece of uniform construction.

8. The washing-stall of claim 1 wherein at least one of said water shield(s) is in the range of 2-24 inches in height, extending upward from the floor.

9. The washing-stall of claim 1 further comprising a threshold.

10. The washing-stall of claim 2 operationally configured so that tile may be affixed thereon on both of said floor and said water shields, so that floor and water shield tile can meet at approximately a right angle near seam folds.

11. The washing-stall of claim 2 operationally configured so that tile may be affixed thereon on both of said floor and on wallboard adjacent to said water shields, so that tile can meet at approximately a right angle near seam folds.

12. The washing-stall of claim 1 wherein said water shield, threshold, and floor are formed of materials within the group consisting essentially of steel, aluminum, alloys, ceramics, plastics, high density polypropylene, polyethylenes, and polyvinylchlorides.

13. The washing-stall of claim 2, wherein said washing-stall is a shower pan.

14. The washing-stall of claim 1 further being operationally configured to connect with a fitted foam support.

15. The washing stall of claim 1 further comprising a fitted foam support.

16. A method of fabricating a washing-stall comprising the steps of:
Obtaining aluminum and fashioning said aluminum into a shower pan defining a floor, at least one drain pipe connector in said floor, and a plurality of water shields;
Coating at least a portion of the surfaces of the floor and water shields of said washing-stall with epoxy;
Applying a friction coating to said epoxy while said epoxy is wet;
Allowing said epoxy and friction to dry.

17. The method of fabrication of claim 16 wherein said aluminum of said shower pan is made with a thickness in the range of 0.020 to 0.060 inches in width.

18. The method of fabrication of claim 16 wherein said water shields are fashioned of a height in the range of 2 to 24 inches.

19. The method of claim 16 further comprising the step of merging said shower pan with a fitted foam support.

20. A method of installing and waterproofing a washing-stall in a room comprising the steps of:
Obtaining a washing-stall defined by a floor, at least one drain pipe connector in said floor, and a plurality of water shields;
Ensuring that a portion of said surfaces of said washing-stall are covered with a friction coating;
Placing at least one water shield of said washing-stall adjacent a wallboard or a wall stud and affixing said washing-stall thereto with a fastening means;
Affixing tile to said friction coating.

21. A method of tiling a washing-stall comprising the steps of
obtaining a washing-stall featuring at least one water shield, at least one threshold, and at least one floor;
ensuring that a friction coating is on a portion of said water shield, threshold, or floor;
affixing a tile to said friction coating.

22. The method of claim 21 wherein said tile is formed of material selected from the group consisting essentially of ceramic, stone, metal, glass, or plastic.

23. The method of claim 19 wherein said washing-stall is formed as a single unit with water tight corner bends and seam folds.
